(19) United States
(12) Patent Application Publication
(10) Pub. No.: US 2016/0123583 A1
(43) Pub. Date: May 5, 2016

(54) RECUPERATOR BURNER

(71) Applicant: NOXMAT GmbH, Oederan (DE)

(72) Inventors: Roland Rakette, Freiberg (DE); Tobias Graemer, Freiberg (DE); Matthias Wolf, Freiberg (DE)

(73) Assignee: NOXMAT GmbH, Oederan (DE)

(21) Appl. No.: 14/933,262

(22) Filed: Nov. 5, 2015

(30) Foreign Application Priority Data
Nov. 5, 2014 (DE) 102014116126.2
Mar. 13, 2015 (EP) 15159026.2
Aug. 20, 2015 (DE) 102015113794.1

(51) Int. Cl. F23L 15/04; B23P 15/26; F23C 9/00

(52) U.S. Cl. CPC F23L 15/04; F23C 9/006; B23P 15/26

(57) ABSTRACT

A recuperator for a recuperator burner for preheating combustion air by means of exhaust gas heat in a recuperator burner is disclosed, wherein the recuperator is of a tubular shape with an inside and an outside, wherein a plurality of elevations or ribs and recesses are provided at least on the inside or on the outside thereof and wherein at least one cellular structure, preferably consisting of a cellular metal or an open-pored ceramic foam, is accommodated in one of the recesses, at least on the inside or on the outside. In this arrangement, the inlet air is preferably preheated twice in the burner head, namely, in a first inlet air duct section, by an exhaust duct coaxially surrounded thereby, using cocurrent flow, and additionally by a second inlet air duct section, which is coaxially surrounded by the exhaust duct, using counter-current flow.

### CROSS REFERENCE TO RELATED APPLICATIONS

This application claims priority from German patent application 102014116126.2 filed on Nov. 5, 2014, from German patent application 102015113794.1 filed on Aug. 8, 2015, and from European patent application 15159026.2 filed on Mar. 13, 2015. The entire contents of these priority applications are incorporated herein by reference.

### BACKGROUND OF THE INVENTION

The invention relates to a recuperator burner having a burner head, on which a combustion tube and an exhaust-guiding tube are held, wherein a recuperator is held between the combustion tube and the exhaust-guiding tube.

The invention furthermore relates to a recuperator for a recuperator burner of this kind.

Recuperator burners have been known for a long time in the prior art. To increase efficiency, recuperator burners have a recuperator, along one side of which exhaust gas is guided and along the other side of which combustion air is guided according to the counter-current principle in order to achieve preheating of the combustion air. Recuperator burners having a ceramic recuperator are known from EP 1 486 728 A2, for instance. In this case, the recuperator has a tube section which serves as a surface for heat exchange with flowing fluids and on which a plurality of folds of corrugated design extending spirally with respect to the longitudinal axis of the recuperator are provided.

A recuperator burner having flattened heat exchanger tubes according to EP 1 995 516 A1 has an even higher efficiency. The metal recuperator for preheating combustion air by means of exhaust gas heat by counter-current flow contains heat exchanger tubes which have a flattened gap cross section in a section used for heat exchange and, at the other end thereof, a nozzle cross section which differs from the gap cross section, wherein the heat exchanger tubes are arranged around a central axis and the ends slope towards the central axis.

The high number of installed heat exchanger tubes, e.g. 72 tubes, leads to a relatively complex and expensive construction as compared with the traditional finned tube recuperators.

### SUMMARY OF THE INVENTION

In view of this, it is a first object of the invention to disclose a recuperator burner having a recuperator of simple and robust construction.

It is a second object of the invention to disclose a recuperator burner having has a high efficiency.

It is a third object of the invention to disclose a recuperator leading to a high efficiency when used in a recuperator burner.

It is a forth object of the invention to disclose a recuperator of simple and robust construction.

It is a fifth object of the invention to disclose a recuperator of very simple and cost-effective design.

It is a sixth object of the invention to disclose a recuperator which is suitable for retrofitting to an existing recuperator burner which is configured according to the state of the art.

These and others objects are achieved in one aspect of the invention by a recuperator recuperator for preheating combustion air by means of exhaust gas heat within a recuperator burner, said recuperator comprising:
a tubular base body having an inside and an outside; and
at least one cellular structure arranged at least on said inside or on said outside, said cellular structure being configured for allowing a fluid flow therethrough in an axial direction of said base body.

According to one aspect of the invention the cellular structure acts to intensify the interaction between the gas flow and the recuperator which results in an improvement in heat transfer and hence in an increase in efficiency.

The cellular structure is not compact but is of cellular design, i.e. has certain cells or pores, giving rise to a coherent hollow structure. This can be a foam, e.g. an open-pored foam. However, other cell structures, which are not randomly oriented as in the case of a foam, for example, but can be of regular orientation or, optionally, can also have a certain texturing, are also conceivable.

The cellular structures may be configured as metal structures or as ceramic structures.

The inventors surprisingly found that the use of cellular structures, such as cellular metals, in the recesses between adjacent elevations makes it possible to achieve considerably improved heat transfer in the recuperator, even without the inserts being held in the recesses by material bonding.

In this way, significantly improved efficiency can be achieved.

In an advantageous development of the invention, the elevations are designed as ribs, which are separated from one another by the recesses in the form of interspaces. Here, the inserts are accommodated in the recesses between adjacent elevations.

According to a development of the invention, the recesses are roughened on the surface thereof.

By means of this measure, an improvement in the fit between the inserts and the recuperator body and an improvement in heat transfer are achieved.

According to another embodiment of the invention, the inserts composed of these cellular metals are press-fitted in the recesses.

This allows simple and low-cost production while nevertheless ensuring high efficiency. Subsequent exchange of the recuperator is possible in principle here.

The inserts can furthermore be held in the recesses by undercuts or can be held by an adjoining tube (e.g. a surrounding exhaust-guiding tube).

This makes possible reliable holding of the inserts, even if the recuperator is a ceramic component, such as one composed of SiSiC.

In a preferred development of the invention, in the assembly process an adhesive is used first and then fixing is performed by means of an adjoining tube. The adhesive disintegrates without remainder during a subsequent annealing treatment, e.g. at about 300° C., with the result that the inserts are held by the tube.

In this way, easier assembly and, at the same time, secure fixing are obtained.

According to another embodiment of the invention, the inserts composed of the cellular metals are held in the recesses by material bonding, which can be accomplished, for example, by means of galvanizing, brazing, welding or sintering in.

It is thereby possible to further increase efficiency somewhat.

According to another embodiment of the invention, the inserts are composed of open-pored metal foam.

The open-pored structure makes it easier for fluids or gases to flow through. Moreover, it is possible to achieve adaptation in respect of the pressure loss through the type and density of the structure.

According to another embodiment of the invention, the inserts are composed of a heat-resistant alloy, which is temperature-stable at least up to 1000° C., in particular up to 1100° C., preferably of an alloy which contains aluminium as a constituent of the alloy.

When using an alloy of this kind, the high thermal demands due to the flow of exhaust gases through the recuperator can easily be met. Particularly alloys which contain aluminium as an alloying element, such as FeCrAl or CrNi—Al alloys, form Al2O3 on the surface, lead to high corrosion resistance.

The recuperator may be composed of metal, in particular steel, preferably stainless steel.

In this way, the thermal expansion coefficients of the recuperator and of the inserts can be matched, making it possible to ensure a permanent and strong connection to the inserts.

The inserts composed of cellular metals can also be used in recuperators composed of ceramic.

Since the use of a press fit is not appropriate here because of the ceramic material, reliable retention can be achieved here particularly by means of undercuts, profiling or the like. As already mentioned above, retention by an adjoining tube, e.g. an exhaust-guiding tube, can be considered. As an alternative or in addition, a materially bonded joint, e.g. by means of adhesive bonding, can be used.

According to another embodiment of the invention, the inserts extend only cover a partial area of the recuperator.

This is expedient particularly if the recuperator is composed of a ceramic material, such as SiSiC. The inserts are then preferably inserted only in the thermally less stressed, colder region of the recuperator, since the thermal stress capacity of the inserts composed of metal is limited.

Retention of the inserts between the recesses can also be ensured, for instance, by the surrounding exhaust-guiding tube of the recuperator burner.

The invention furthermore discloses a recuperator burner having a burner head, on which a combustion tube and an exhaust-guiding tube are held, wherein a recuperator of the type described above is held between the combustion tube and the exhaust-guiding tube.

A recuperator burner of this kind is distinguished by increased efficiency in comparison with conventional recuperator burners, combined with the same or less noise development.

According to another embodiment of the invention, a gap, which is at least partially filled with the inserts, is in each case formed between the recuperator and the exhaust-guiding tube and between the combustion tube and the recuperator.

Overall, efficiency is further improved if the gaps between the combustion tube and the recuperator and between the exhaust-guiding tube and the recuperator are largely closed by means of the inserts.

As regards the recuperator burner, the invention is furthermore achieved by a recuperator burner having a burner head, on which a combustion tube and an exhaust-guiding tube are held, wherein a recuperator is held between the combustion tube and the exhaust-guiding tube, wherein the burner head is designed as an air part through which exhaust gas flows, which has an exhaust duct and an inlet air duct, which are arranged coaxially with one another, wherein the inlet air duct has a first inlet air duct section, which at least partially surrounds the exhaust duct coaxially from the outside, and the exhaust duct partially surrounds a second inlet air duct section coaxially from the outside.

In this way too, the object of the invention is fully achieved.

By means of the embodiment of the recuperator burner according to the invention, increased heat exchange within the burner head is ensured in as much as the exhaust gas flow is surrounded on both sides by the combustion air flow and hence the combustion air flow is guided both as a co-current and also as a counter-current with respect to the exhaust gas flow.

A significant improvement in firing efficiency is thereby obtained.

In combination with the recuperator described above, a further improvement in efficiency can be achieved, this being above 84% to 85%, approximately in the region of up to 90%.

Here, the first inlet air duct section is preferably connected to the second inlet air duct section by a radial connecting section. The exhaust duct thus adjoins the inlet air duct both from the inside and from the outside, thus ensuring effective preheating of the inlet air.

According to another embodiment of the invention, the recuperator is fitted to the exhaust duct in such a way as to allow the exhaust gas to flow axially from the outside of the recuperator into the exhaust duct.

In this way, advantageous assembly and favourable flow behaviour are ensured.

The recuperator according to the invention can furthermore also be used with a recuperator burner that has a lateral stub for carrying away the exhaust gas and for preheating combustion air.

This also makes possible retrofitting of existing burners with the recuperator according to the invention since, in this case, only the stub has to be adapted in an appropriate manner.

According to an alternative design the cellular structures are made from a ceramic material using, in particular, 3D-printing.

It is self-evident that the features of the invention which are mentioned above and those which remain to be explained below can be used not only in the respectively indicated combination but also in other combinations or in isolation without exceeding the scope of the invention.

### BRIEF DESCRIPTION OF THE DRAWINGS

Further features and advantages will emerge from the following description of preferred embodiments with reference to the drawing, in which:

FIG. 1 shows a longitudinal section through a recuperator burner according to the invention;

FIG. 2 shows an enlarged longitudinal section through the front end of the recuperator burner, on which the exhaust-guiding tube has additionally been mounted;

FIG. 3 shows a perspective view of the recuperator shown in FIG. 1;

FIG. 4 shows an enlarged cross section of the recuperator but without inserts composed of cellular metals;

FIG. 5 shows a recuperator embodiment which has been modified slightly as compared with the embodiment shown in FIG. 4, having a modified rib shape, once again without inserts composed of cellular metals;

FIG. 6 shows a photograph of the outer surface of a recuperator according to the invention;

FIG. 7 shows a partial section through the recuperator according to the invention in an enlarged view, having a schematically indicated insert between two adjacent ribs;

FIG. 8 shows a partial section through a modified embodiment of a recuperator according to the invention, on which undercuts for fixing the inserts are provided;

FIG. 9 shows a partially sectioned side view of a modified embodiment of a recuperator burner having a recuperator, in which the inserts composed of cellular metals extend only over a cooler partial area of the recuperator;

FIG. 10 shows an enlarged section through the recuperator burner shown in FIG. 8;

FIG. 11 shows another embodiment of a recuperator in longitudinal section with a laterally flanged-on stub for carrying away the exhaust gas and combustion air supply by means of a recuperator according to the invention;

FIG. 12 further embodiments of a recuperator shown is three variants, namely (a) with a layer of a cellular metal which is partially presses into the recesses between the ribs and held by a surrounding exhaust air guiding tube, (b) with inserts which are first pressed into the recesses and are then secured by an outer layer of a cellular metal and a surrounding exhaust air guiding tube, and (c) with two outer layers of a cellular metal which rest directly on the recuperator surface, without any ribs on the outside;

FIG. 13 an enlarged cross-section through a ceramic recuperator with several exemplary designs of cellular structures held within the recesses between adjacent elevations;

FIG. 14 an alternative embodiment a cellular structure shown as a cutout of an enlarged perspective;

FIG. 15 an alternative embodiment a cellular structure shown as a cutout of an enlarged perspective;

FIG. 16 an enlarged perspective cutout of a further modification of a cellular structure in the shape of pyramides; and

FIG. 17 an enlarged perspective cutout of a further modification of a cellular structure in the shape of cross-structures.

### DESCRIPTION OF PREFERRED EMBODIMENTS

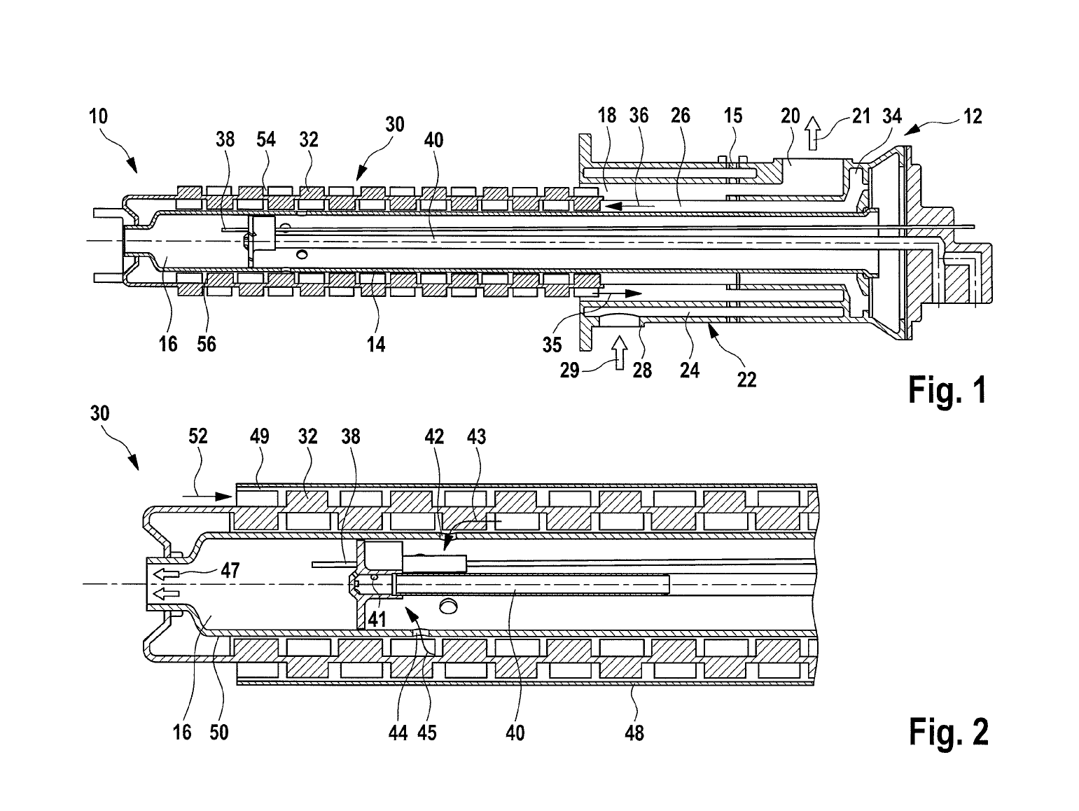

In FIG. 1, a recuperator burner according to the invention is shown in longitudinal section and denoted overall by numeral 10.

It should be noted that the figures are not drawn to scale and have been partially modified in their proportions for reasons of greater clarity.

The recuperator burner 10 has a burner head 12, on which is held a combustion tube 14, at the outer end of which a combustion chamber 16 is formed, into which fuel can be fed via a fuel lance 40.

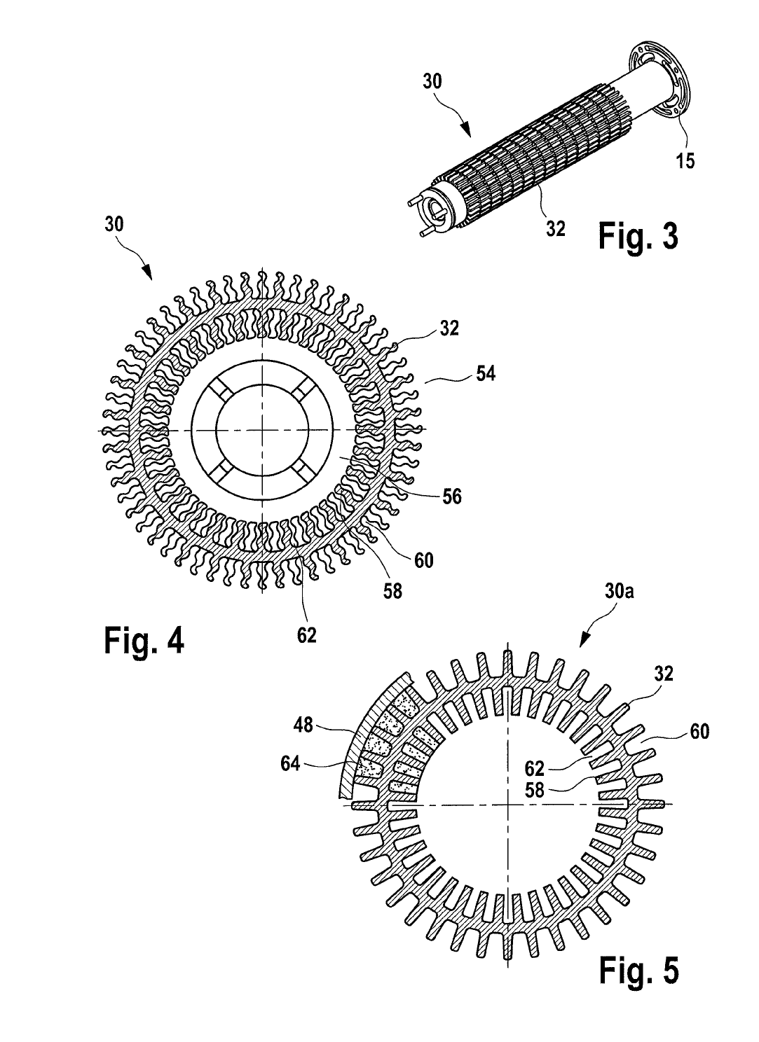

A recuperator 30 is furthermore held on the burner head 12, said recuperator being mounted on the burner head 12 by means of a flange 15 at a certain distance from the outer axial end of said burner head. The recuperator 30 has a multiplicity of ribs 32, as will be described below in greater detail with reference to FIGS. 3 to 5.

According to FIG. 1, the burner head 12 has a lateral inlet air stub 28, into which inlet air enters into an inlet air duct 22 in accordance with arrow 29. The inlet air duct 22 has a first inlet air duct section 24, into which the inlet air stub 28 opens directly. This first inlet air duct section 24 extends coaxially with the combustion tube 14 and, as can be seen from FIG. 2, is connected by a connecting section 34 to a second inlet air duct section 26, which likewise extends coaxially with the combustion tube 14 but is in direct proximity to the combustion tube 14, while the first inlet air duct section 24 is offset radially outwards relative to the second inlet air duct section 26. An exhaust duct 18 extends between these inlet air duct sections 24 and 26. On its inside, the exhaust duct 18 thus adjoins the second inlet air duct section 26 and, on its outside, adjoins the first inlet air duct section 24.

From FIG. 1, it can be seen that the exhaust duct 18 opens radially outwards via an exhaust stub 20, with the result that the exhaust gas emerges outwards in accordance with arrow 21 and is passed into a suitable connected exhaust line. The exhaust gas enters the exhaust duct 18 in the axial direction on the outside 54 of the recuperator 30, as indicated by arrow 35.

In principle, the recuperator 30 is a tube along the outside 54 of which a sequence of ribs 32 is formed and on the inside 56 of which a sequence of ribs 58 is likewise provided.

As can be seen from FIG. 3, a certain axial section of ribs 32 in each case extends around the entire outer circumference, while the subsequent ribs 32 are arranged offset with respect to the preceding ribs. Arrangements without an offset are, of course, also conceivable.

The arrangement on the inside 56 of the recuperator 30 is made in a corresponding way.

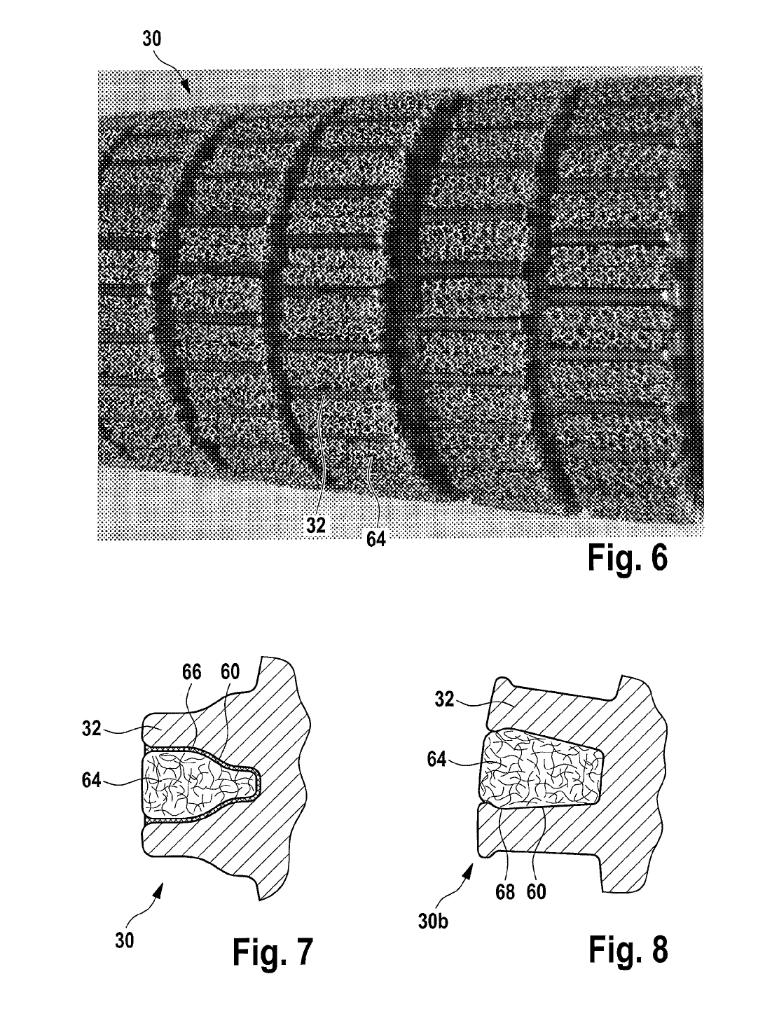

According to the invention, the interspaces or recesses 60 between adjacent ribs 32 are now in each case provided with an insert 64 (cf. FIGS. 6, 7, 8) composed of a cellular structure.

This is preferably an open-pored metal foam, which is preferably composed of a high-temperature-resistant alloy containing aluminium as a constituent of the alloy, such as an FeCrAl alloy or a CrNi—Al alloy. High corrosion resistance is thereby obtained through the formation of Al₂O₃ on the surface.

There are various methods for producing cellular metallic materials, cf, for instance, J. Banhart: “Manufacture, characterisation and application of cellular metals and metal foams”, Progress in Materials Science 46 (2001) 559-632, which gives an overview of the various production methods and applications. According to this, cellular metals can be produced by four different process routes:

a) by vacuum deposition of metal vapor,

b) in the liquid metal phase,

c) by a method involving powder,

d) production by means of metal ions by electrochemical deposition.

According to b), production can be performed by direct foaming with gas in the liquid metal phase or by direct foaming with gas-releasing reagents. Production by means of “gasars” (solid-gas eutectic solidification exploiting the fact that some liquid metals form a eutectic system with hydrogen gas) is furthermore possible. Melting of solidified powders is furthermore possible. This method begins with the mixing of metal powders and binders with a gas-releasing reagent, after which the mixture is compacted in order to obtain a dense semi-finished product. Subsequent heat treatment at temperatures close to the melting point of the matrix material causes the gas-releasing reagent to decompose, as a result of which the compacted semi-finished product expands and forms a highly porous structure. This method is known with aluminum and TiH₂ powder as the gas-releasing reagent. It is also possible to foam steels, e.g. using carbonates, such as SrCO₃. Metal hydrides can also be used.

According to c), by a method involving powder, sintering of metal powders and fibres can be performed. In general, a metal powder is first of all produced and fractionated and prepared, then compacted or molded and finally sintered. If it is only slightly compacted, a high porosity can be achieved. As an alternative, gases can be enclosed during compaction, these gases leading to expansion during subsequent sintering. It is furthermore possible to produce metal foams by means of a slip comprising metal powders, gas-releasing reagents and additives. After mixing, the slip is poured into a mould and is then initially held at elevated temperatures until the gas-releasing reagents expand and the expanded slip is completely dried. After sintering, this gives a metal foam of relatively high strength. It is furthermore possible to produce cellular metals on the basis of spacing fillers.

Finally, hollow spheres of copper, nickel, steel or titanium can be used to produce highly porous structures by a process in which the individual spheres are joined together by sintering.

There are therefore various possible production methods available for the production of the inserts. In this regard, the above publication by J. Banhart is incorporated fully by reference.

If the cellular structures are made of ceramic materials, the preferred method of preparation is by printing the structure with a 3D-printer using a precursor material which is dried thereafter and then fired at high temperature such as 1200° C. or even higher depending on the nature of the ceramic material.

When using cellular metals as cellular material, the outer surface of each recess 60 is preferably roughened, e.g. by sandblasting, and the respective insert 64 is pressed into the recess 60 and held therein by means of a press fit.

As an alternative, shown in FIG. 7, it is conceivable to produce a materially bonded joint, e.g. by means of an adhesive or a brazing alloy.

In a corresponding way, the inserts on the inside 56 are in each case pressed into the interspaces or recesses 62 between adjacent ribs 58.

The efficiency of the recuperator 30 is significantly improved by these inserts 64.

As can be seen from FIG. 1, the main part of the combustion air enters the interior of the combustion tube 14 through associated openings 42, 44 in the combustion tube 14. Finally, mixing with the fuel fed in via the fuel lance 40 and exit into the combustion chamber 16 take place via associated openings in a swirl plate 41. From the combustion chamber, the gas emerges into the boiler, as indicated by arrow 47 in FIG. 2. A small portion of the combustion air flows past the combustion chamber 16 on the outside and emerges at the recuperator tip.

An associated ignition electrode 38 ensures ignition of the mixture. The flames emerge from the combustion chamber 16 via the axial end into the volume to be heated. As shown in FIG. 2, exhaust gases from the volumes to be heated pass on the outside into the gap 49 between the exhaust-guiding tube 48 and the recuperator 30, as indicated by arrow 52 in FIG. 2, and flow through the gap 49, on the one hand, and through the interspaces between the ribs 32, through the inserts 64, on the other hand, and finally into the exhaust duct 18 of the burner head 12 in the axial direction at the end of the rib structure.

According to FIG. 2, there is also a certain gap 50 between the recuperator 30 and the outer surface of the combustion tube 14. As far as possible, the inserts 64 extend to such an extent in the radial direction that the gap 50 is reduced as far as possible.

In the burner head 12 there is heat transfer from the exhaust gas in the exhaust duct 18 to the combustion air in the second inlet air duct section 26, based on the counter-current principle. In addition, there is additionally a further heat transfer in the burner head 12 from the exhaust gas in the exhaust duct 18 to the combustion air in the first inlet air duct section 24, involving co-current flow.

By virtue of this double preheating of the inlet air in the burner head 12, there is a further increase in efficiency.

By virtue of the first measure—using inserts 64 composed of metal foam in the interspaces between the ribs 58 both on the outside 54 and on the inside 56 of the recuperator—there is an increase in the firing efficiency to about 84% to 85%. This is about 9% higher than with comparable standard burners with ribbed recuperators (in each case at an exhaust gas inlet temperature of 1000° C.).

The recuperator burner 10 according to the invention furthermore has a comparatively low sound pressure level. This is about 60 dB (A), whereas the level for standard burners with ribbed recuperators is 71 to 73 dB (A).

By virtue of the second measure—preheating the inlet air in the burner head 12 both from the inside and from the outside by means of the two inlet air duct sections 24, 26—there is a further increase in firing efficiency, with the result that the overall efficiency is up to about 90%.

FIG. 4 shows the recuperator 30 according to FIG. 1 in cross section.

A slightly modified embodiment of the recuperator as compared with the embodiment of recuperator 30 is shown in FIG. 5 and is denoted overall by 30a. Here, corresponding reference signs are used for corresponding parts. In this case, the ribs 32 are not corrugated, as in the embodiment shown in FIG. 4, but are flat.

In FIG. 5, the inserts 64 are shown in addition. While the inserts 64 are held in the recesses 62 on the inside by virtue of the shape, additional fixing is necessary on the outside. Here, the surrounding exhaust-guiding tube 48 is used to hold the inserts 64 in the recesses 60.

In the photograph in FIG. 6, the open-pored, cellular structure of the inserts is clearly visible. FIG. 7 shows a modification, according to which the inserts 64 are held in the recesses 60 by an adhesive layer 66.

FIG. 8 shows a modification of the recuperator 30b in which the inserts are held in the recesses 60 by means of undercuts 68.

An embodiment of this kind also allows fixing in the case of a ceramic recuperator 30b by inserting the inserts 64 axially.

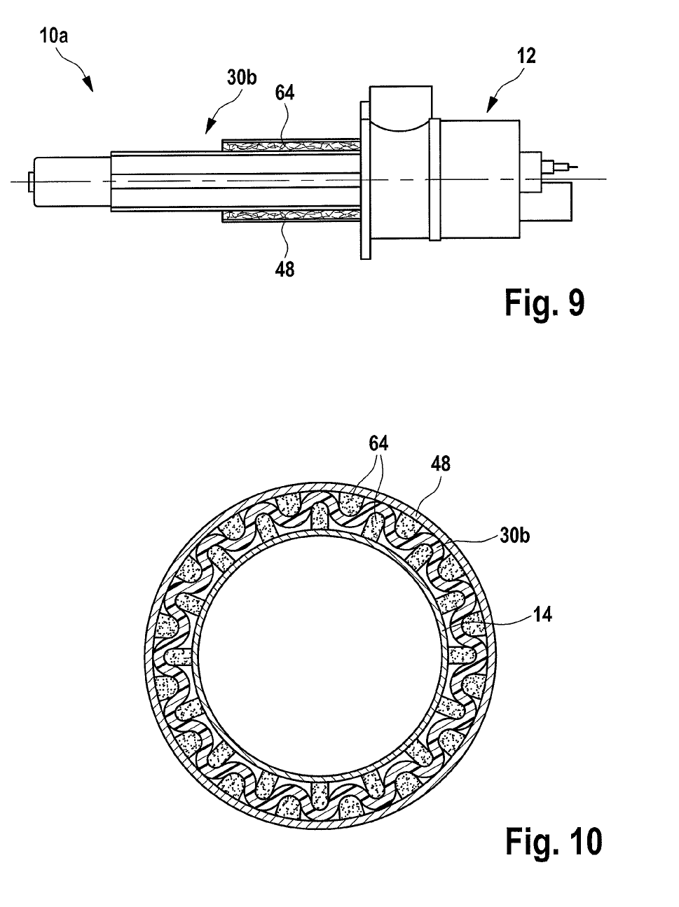

FIG. 9 shows a recuperator burner having a ceramic recuperator 30b in partially sectioned side view. Here, the inserts 64 preferably extend over only part of the recuperator 30b, namely over the cooler part, which heats to a maximum of about 1000 to 1050° C., since the temperature stability of the metallic inserts 64 is limited.

FIG. 10 shows the ceramic recuperator 30b composed of SiSiC having the inserts 64. Because of the corrugated cross section of the recuperator 30b, fixing of the inserts 64 by press-fitting or by undercuts is hardly possible. Instead, the inserts 64 are held in the respective recesses by the adjoining tubes (on the outside by the exhaust-guiding tube 48 and on the inside by a fixing tube).

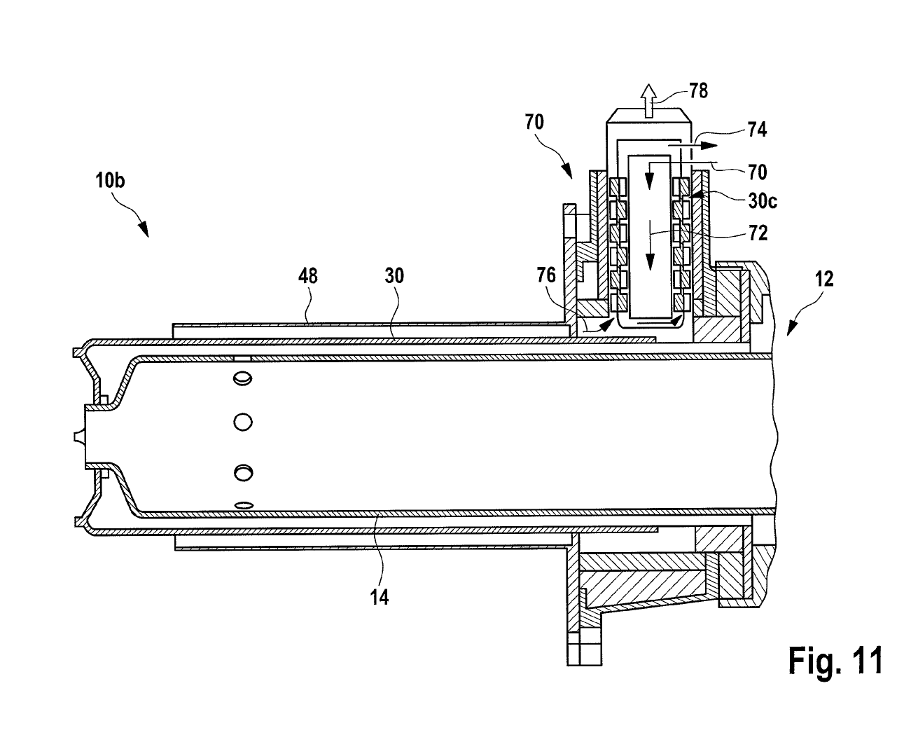

Another modification of a recuperator burner is shown in FIG. 11 and is denoted overall by reference sign 10b. This recuperator burner has a lateral stub 70, by means of which the exhaust gas is carried away and the combustion air is preheated. The inlet air is fed in centrally as indicated by arrows 70, 72, is preheated in the recuperator 30c on the stub 70 and is guided out again in accordance with arrow 74 and then passed into the interspace between the recuperator 30 and the combustion tube 14 in a manner not shown specifically.

As indicated by arrow 76, the exhaust gas reaches the short recuperator 30c on the stub 70, preheats the inlet air and finally emerges at 78 into a connected exhaust line (not shown). Here too, inserts 64 are preferably situated in the short recuperator 30c in order to improve heat transfer (not shown). A recuperator 30c of this kind on the stub 70 can easily be retrofitted on existing recuperator burners.

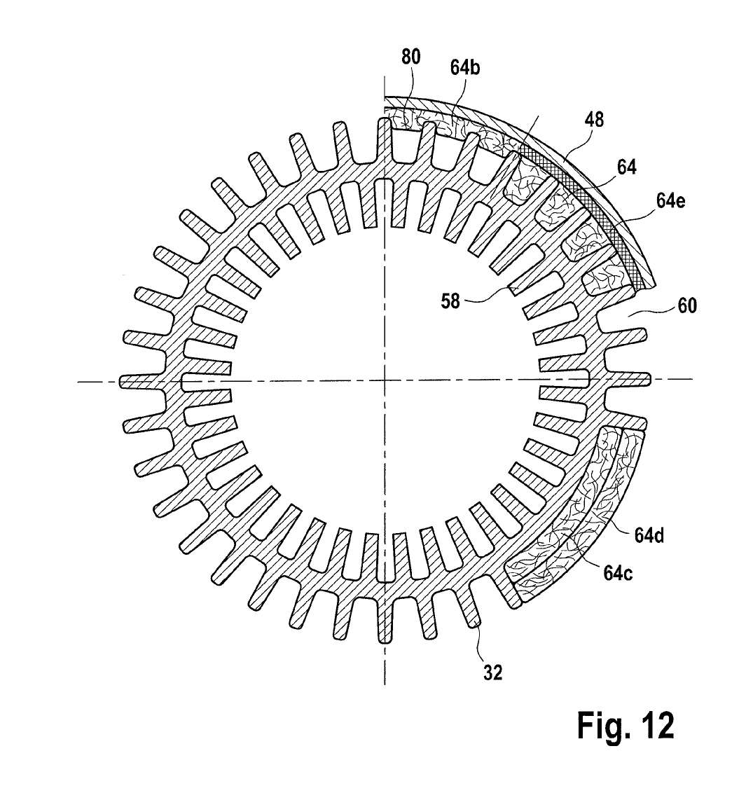

FIG. 12 shows a further cross-section through a recuperator according to the invention, shown with three modifications.

In a first embodiment the insert 64b is made of a cellular metal as an integral layer which is only rolled around the outer ribs 32 and held by a final exhaust guide tube 48. Herein, the cellular metal comprises small protrusions 80 which protrude somewhat into the recesses. This leads to a simplified mounting which is very cost-effective.

In the following section of FIG. 12 inserts 64 are shown which are placed into the recesses 60 from the outside and are held by a surrounding layer 64e of a cellular metal and an outer exhaust guide tube 48.

If the inserts 64 are prepared by a suitable method, such as water jet cutting, laser cutting or eroding, they usually have a surface which can easily hook into a surface of a recess 60. By the subsequent layer 64e of a cellular metal and an outer exhaust guide tube 48 a secure fixing is ensured. A slightly more complicated mounting procedure leads to a considerably increased in efficiency.

Finally, in the right lower part of FIG. 12 a very simple and cost-effective design is shown. In this case, there are no ribs on the outside. Instead, only rolling at least one layer of cellular metal around the outer surface of the recuperator is performed. In this case two layers 64c and 64d are used.

This leads to a very simple design with only a slightly reduced efficiency. Basically, also on the inside of the recuperator ribs and inserts may be used or, possibly also on the inside one or more layers of cellular metals may be used.

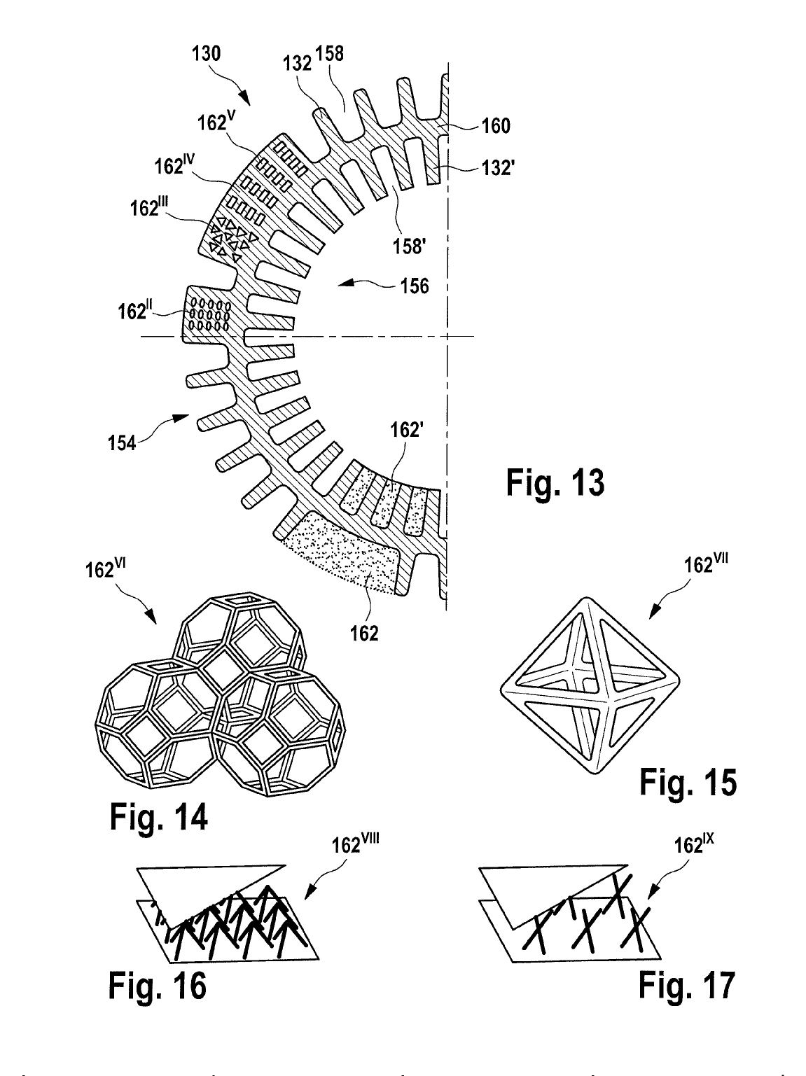

In FIG. 13 further modifications of a recuperator 130 according to the invention are shown.

In this case recuperator 130 is a ceramic recuperator 130 being integral with cellular ceramic structures. Along the outer side 154 of the recuperator 130 a sequence of ribs 132 is provided. Also on the inner side 156 a sequence of ribs 132′ is provided. Between adjacents ribs 32, 32′ recesses 158, or 158′ are formed, respectively.

According to the invention, the recesses or depressions 158, 158′ between adjacent ribs 132, 132′ are each filled with cellular ceramic structures which are shown in different configurations in FIG. 13 and are denoted with 162, 162′, 162″, 162″′, 162^{IV}, 162^{V}.

The recuperator 130 comprises a solid ceramic base body 160, whereon the ribs 132, 132′ are formed with the recesses 158, 158′ between adjacent ribs 132, 132′.

The cellular structures 162, 162′, 162″, 162″', 162^{IV}, 162^{Vv} may be configured as an open-porous ceramic foam, such as indicated in FIGS. 13 at 162 and 162′.

However, any other ceramic structures which allow a sufficient fluid flow in axial direction are conceivable. These structures may be similar to cellular metals. They may also have an irregular or a regular shape. In FIG. 13 some structures are indicated with 162″, 162″', 162^{IV}, 162^{V}.

FIG. 14 shows an open porous foam structure 162^{VI} with only three pores having pentahedric open surfaces shown. FIG. 15 shows one pore of an octahedric cellular structure 162^{VII}.

FIGS. 16 and 17 show further cellular structures 162^{VIII} and 162^{IX} configured as regular lattice structures with pyramides (FIG. 16) and cross-structures (FIG. 17).

Further lattice structures with meshes or loops, cuboids, prisms, etc. are conceivable.

The ceramic cellular structures may be prepared by any suitable ceramic shaping method, such as pressing, hot pressing, isostatic pressing isostatic hot pressing, slip casting, 3D-printing.

In particular 3D-printing is readily available for producing particular regular or irregular structures using a ceramic precursor material.

In a first configuration, first the ceramic base body 160 is prepared by a known ceramic shaping method, such as pressing, hot pressing, isostatic pressing, isostatic hot pressing, slip casting. Thereafter, onto the so prepared green body the cellular structures 162, 162′, 162″, 162″′, 162^{IV}, 162^{V}, 162^{VI}, 162^{VII}, 162^{VIII}, 162^{IX} are applied by 3D-printing. Thereafter, the green body is first dried (e.g. at 150° C.) and then fired at sufficiently high temperature such as at 1400° C. or 1500° C. to effect a full sintering. The firing temperature, naturally depends on the particular ceramic material that is selected, such as aluminum oxide, zirconium oxide or SiSiC. The latter however, requires as specific route of preparation (see below).

In a modification the ceramic base body 160 may be prepared by a known ceramic shaping method, such as pressing, hot pressing, isostatic pressing, isostatic hot pressing, slip casting, and may thereafter be fired first to yield a solid ceramic base body by sintering. Onto the base body thereafter the ceramic cellular structures may be applied by 3D-printing, subsequent drying and sintering.

For preparing an SiSiC ceramic, 3D-printing may be used for preparing a green body form a suitable ceramic precursor material. After drying the green body is fired to yield a porous precursor body, which subsequently is transformed into a SiSiC ceramic by liquid or gaseous silicating.

1. A recuperator for preheating combustion air by means of exhaust gas heat in a recuperator burner, said recuperator comprising:
a tubular base body having an inside and an outside; and
at least one insert made of a cellular metal being configured for allowing a fluid flow therethrough in an axial direction of said base body.

2. The recuperator of claim 1, further comprising a plurality of elevations and recesses, each one of said recesses being arranged between adjacent elevations provided on said base body, wherein said at least one insert comprises a plurality of cellular inserts arranged at least partially within said recesses.

3. The recuperator of claim 2, wherein said elevations are configured as ribs being separated from one another by said recesses being configured as interspaces.

4. The recuperator of claim 2, wherein said inserts are press-fitted in said recesses.

5. The recuperator of claim 2, wherein said recesses further comprise undercuts for holding said inserts.

6. The recuperator of claim 2, wherein said recesses are roughened at a surface thereof.

7. The recuperator of claim 2, wherein said inserts are held in said recesses by material bonding.

8. The recuperator of claim 2, wherein said inserts are held in said recesses by a method selected from the group consisting of adhesive bonding, galvanizing, brazing, welding, and sintering.

9. The recuperator of claim 2, wherein said inserts are held in said recesses by a tube resting thereon.

10. The recuperator of claim 2, wherein said inserts are made of open-pored foam made of a material selected from the group consisting of a metal and a ceramic.

11. A recuperator burner comprising:
a burner head;
a combustion tube arranged on said burner head;
an exhaust-guiding tube arranged on said burner head;
a recuperator arranged between said combustion tube and said exhaust-guiding tube;
an exhaust duct arranged on said burner head; and
an inlet air duct arranged on said burner head coaxially with said exhaust duct;
wherein said inlet air duct comprises a first inlet air duct section which at least partially surrounds said exhaust duct coaxially from outside, and wherein said exhaust duct partially surrounds a second inlet air duct section coaxially from outside.

12. A recuperator for preheating combustion air by exhaust gas heat in a recuperator burner, said recuperator comprising:
a tubular base body having an inside and an outside; and
at least one cellular structure arranged at least on said inside or on said outside, said at least one cellular structure being configured for allowing a fluid flow therethrough in an axial direction of said base body.

13. The recuperator of claim 12, further comprising:
a plurality of elevations and recesses, each one of said recesses being arranged between adjacent elevations provided on said base body, wherein said at least one cellular structure comprises a plurality of cellular structures arranged at least partially within said recesses.

14. The recuperator of claim 12, wherein said cellular structure is configured as a foam having an open pore structure.

15. The recuperator of claim 13, wherein said elevations are arranged at regular intervals along an inner or an outer surface of said base body.

16. The recuperator of claim 13, wherein said elevations are arranged parallel to a longitudinal axis of said recuperator or at an angle to said longitudinal axis.

17. The recuperator of claim 13, wherein said elevations are configured as ribs.

18. The recuperator of claim 13, wherein said at least one cellular structure is made of a ceramic precursor by 3D-printing and firing.

19. The recuperator of claim 13, wherein said base body is configured as a ceramic body being integral with said at least one cellular structure.

20. The recuperator of claim 13, wherein said base body and said at least one cellular structure are made of materials selected from the group consisting of SiSiC, zirconium oxide, and aluminum oxide.

21. A method of making a ceramic recuperator comprising the steps of:
preparing a solid tubular shaped base body from a ceramic precursor by a ceramic shaping method;
applying a cellular structure made of a ceramic precursor at least to at least one side of said base body selected from the group consisting of an inner side and an outer side of said base body; and
firing said base body with said at least one cellular structure.

22. The method of claim 21, wherein said ceramic shaping method is selected form the group consisting of pressing, hot pressing, isostatic pressing, isostatic hot pressing, slip casting, and 3D-printing.
